(19) United States
(12) Patent Application Publication
(10) Pub. No.: US 2023/0382693 A1
(43) Pub. Date: Nov. 30, 2023

(54) APPARATUS AND METHOD FOR DETERMINING THE SPATIAL POSITION OF PICK-UP ELEMENTS OF A CONTAINER

(71) Applicant: SICK AG, Waldkirch (DE)

(72) Inventors: Dominic RUH, Freiburg (DE); Steffen WITTMEIER, Waldkirch (DE)

(21) Appl. No.: 18/203,638

(22) Filed: May 30, 2023

(30) Foreign Application Priority Data
May 31, 2022 (EP) 22176418.6

(51) Int. Cl. B66C 13/46; G01S 17/88; G01S 17/42

(52) U.S. Cl. CPC B66C 13/46; G01S 17/88; G01S 17/42

(57) ABSTRACT

An apparatus and a method are provided for determining the spatial position of pick-up elements of a container. A respective set of spatial coordinates of points is determined for a plurality of mutually different sensor positions by means of a moving sensor. The points lie in a spatial region that comprises a container. The respective sets of spatial coordinates are combined into a fused totality of coordinates by means of an evaluation unit. The evaluation unit determines a respective spatial position of the pick-up elements of the container based on the fused totality of the coordinates of the points.

The present invention relates to an apparatus and to a method for determining the spatial position of pick-up elements of a container.

The handling of containers plays a central role in the automation of modern ports. To move a container, i.e. to pick it up, transport it and set it down again, an STS crane (Ship To Shore) or an RTG crane (Rubber Tyred Gantry) is used. The STS or RTG crane has a trolley comprising a spreader to which so-called twistlocks are attached. The twistlocks are provided to engage into and to be fastened in pick-up elements of a container. After the spreader has been fastened to the container by means of the twistlocks, the container can be lifted by means of the trolley of the STS or RTG crane and transported to a desired position at which the container is set down again.

To be able to pick up and lift the container as part of an automated process, it is necessary to precisely determine the position of the pick-up elements, for example, so-called corner castings. Furthermore, it should be possible to examine the condition of the pick-up elements or corner castings in order, for example, to determine whether they are defect-free or whether a twistlock is present and/or correctly attached in a respective corner casting.

For example, LIDAR technology or similar optical sensor technology can be used to determine the position and the condition of pick-up elements or corner castings of a container. However, with such technologies, the spatial resolution is usually not sufficient to reliably determine the position and the condition of pick-up elements or corner castings of a container.

An object of the invention consequently consists of providing an apparatus and a method by which the spatial position of pick-up elements of a container can be reliably determined.

This object is satisfied by an apparatus and a method having the features of the independent claims.

The apparatus comprises a moving sensor and an evaluation unit. The moving sensor is configured to determine a respective set of spatial coordinates of points for a plurality of mutually different sensor positions. The points lie in a spatial region that comprises a container. The evaluation unit is configured to combine the respective sets of spatial coordinates into a fused totality of coordinates. The evaluation unit determines a respective spatial position of the pick-up elements of the container based on the fused totality of the coordinates of the points.

The moving sensor can be configured as a LIDAR sensor by which a predetermined spatial region can be scanned that is predefined by the field of view of the LIDAR sensor. The sensor can therefore be configured for distance measurement, for example, by measuring the time of flight of light pulses transmitted by the sensor. The spatial position of e.g. a point of the surface of the container can be determined as spatial coordinates by each distance measurement.

Furthermore, the moving sensor can be configured as a two-dimensional laser scanner, wherein a light beam generated by a laser periodically scans a predetermined spatial region by means of a deflection unit. The light is remitted at objects in the spatial region (e.g. the surface of a container) and is evaluated in the scanner. The angular location of the object is concluded from the angular position of the deflection unit and the distance of the object from the laser scanner is additionally concluded from the time of flight while using the speed of light. The location of an object in the spatial region is detected in two-dimensional polar coordinates using the angular data and distance data. The positions of objects can thus be determined or their contour can be determined. Alternatively, the moving sensor can be configured as a three-dimensional laser scanner, wherein a relative movement in the transverse direction is likewise detected, for example, by a further degree of freedom of movement of the deflection unit in the laser scanner. Three-dimensional contours can thus also be measured.

The movement of the sensor can take place by attaching it to a trolley of a crane above the container. In this case, the sensor can, for example, move with the trolley in the transverse direction of the container and with the crane in the longitudinal direction of the container. Alternatively or additionally, the sensor can be attached for movement to a device that rotates or tilts the sensor, for example, with respect to the trolley of the crane. In general, the term “moving sensor” thus refers to a relative movement of the sensor with respect to the container that can comprise both a rotation and a translation.

The spatial coordinates of the points of the respective set are preferably defined with respect to a fixed spatial point, for example, with respect to an initial position of the moving sensor. The spatial coordinates, for example, further comprise Cartesian x, y, and z coordinates of the respective points. The spatial position of the pick-up elements of the container comprises, on the one hand, their position in space including their dimensions and, on the other hand, the spatial orientation of the pick-up elements, i.e. three solid angles that are defined in that coordinate system to which the spatial coordinates of the points refer. Coordinates of points in the respective sets can further be determined at outer surfaces of the container.

The combination of the respective sets of spatial coordinates of the points into a fused totality of coordinates can take place such that the respective sets of spatial coordinates for the respective sensor position are transferred or transformed into a common world coordinate system. If the sensor is attached to a trolley of a crane, a respective transformation matrix for the corresponding set of coordinates can, for example, be determined based on the current position of the trolley and/or the crane. Additionally or alternatively, such a transformation matrix can consider the position and orientation of a device that can be provided to rotate and/or tilt the sensor.

The transformation of the coordinates to generate the fused totality can only comprise a vector addition of, for example, the x, y, and z coordinates of a point or measurement point and the current position of the trolley in the predefined world coordinate system. However, the transformation can also include a rotation between the sensor coordinate system and the world coordinate system. Both cases can be realized by left multiplication of the coordinates with a homogeneous transformation matrix (4×4 matrix).

On the one hand, the determination of the spatial position of the pick-up elements can take place directly based on the fused totality of the coordinates of the points that are detected as a whole by means of the moving sensor. For example, with a known geometry of the pick-up elements of the container, a model of a respective pick-up element can be adapted to a “cloud” of detected points in a predefined spatial region. The predefined spatial region for such an adaptation can, for example, be defined based on a known container geometry as a region in which the respective pick-up element is most likely to be located.

Alternatively, the spatial position of the pick-up elements can be determined indirectly by first determining the spatial position of the container as a whole. Subsequently, the spatial position of the respective pick-up elements can be determined based on the determined spatial position of the container and based on a known container geometry.

The use of “prior knowledge” with respect to the container, e.g. in relation to the predefined spatial region of the container or its spatial position, can reduce the amount of data to be processed by the evaluation unit. The computer engineering effort that is required to operate the apparatus can thereby be reduced. Furthermore, the processing speed can increase.

The pick-up elements of the container are, for example, fastening receptacles or corner castings to which the container can be fastened for lifting. However, the pick-up elements of the container are not necessarily located in respective corners at the upper side of the container.

Since a plurality of sets of spatial coordinates for the mutually different sensor positions are fused together, on the one hand, the spatial resolution is increased compared to a non-moving sensor, in particular when the spatial regions overlap in which the respective sets of the spatial coordinates of points are acquired. Furthermore, due to the fusion of the plurality of sets of spatial coordinates of the points, the spatial field of view is expanded compared to a non-moving sensor. Due to the increase in the resolution and the expansion of the field of view, the spatial position of the pick-up elements of the container can be determined more precisely and reliably.

The handling or the transport of the container can thus take place in a simpler and faster manner and a higher degree of automation can be achieved since, for example, the time effort for an optional manual check is reduced, for example, before lifting the container. Furthermore, the risk of accidents that is associated with such a check or inspection, for example by a port employee, is also reduced. Advantageous further developments of the invention are set forth in the dependent claims, in the description, and in the drawings.

In accordance with an embodiment, the plurality of mutually different sensor positions can be associated with a respective point in time at which the moving sensor acquires a respective set of the spatial coordinates of the points.

In this embodiment, the sensor can be fixedly attached to a crane, for example to its trolley, that is provided to move the container. The sensor is thus merely moved along with the crane or the trolley and a respective set of spatial coordinates of the points, which, for example, covers a part region at the surface of the container, can, for example, be acquired at predefined points in time and/or with equal time intervals between them. With such a fixed installation of the sensor, for example at the crane or at the trolley, further elements for moving the sensor are dispensed with so that consequently no maintenance effort is required for such elements.

The moving sensor can comprise one or more sensors and a device for respectively tilting the one sensor or the plurality of sensors. A mechanical unit for tilting the sensor, which is also designated as a swivel unit, can be provided. The one or more sensors can in turn be attached to a trolley of a crane, said crane being provided to move the container.

If the sensor is, for example, configured as a three-dimensional scanner that can completely detect an upper side of the container, such an embodiment of the apparatus cannot rely on a movement of a crane and/or of a trolley thereof to be able to acquire the spatial coordinates of points at mutually different sensor positions. Rather, different sensor positions can already be set by means of the device for tilting. However, the device for tilting is associated with additional costs and requires an additional maintenance effort compared to a sensor that is fixedly installed at a crane and merely moves along with it. The sensor can further additionally be moved with a trolley of a crane to which the sensor can be attached, in particular when the sensor cannot fully detect the upper side of the container, such as in the case of a line scanner. Overall, an increase in the resolution and an expansion of the field of view of the apparatus result in such an embodiment.

In accordance with a further embodiment, the sensor can be attached to a trolley of a crane, said crane being provided to move the container. The evaluation unit can further be configured to detect a current position of the trolley and to determine a respective one of the mutually different sensor positions based on the current position of the trolley.

In this embodiment, the position of the trolley is thus tracked to define the mutually different sensor positions at which the respective sets of the spatial coordinates of the points are acquired. A measurement signal that indicates the current position of the trolley in relation to the crane can be present and available anyway as part of the control of the crane or can be measured by an additional measurement unit (e.g. by an inertial measurement unit (EMU) or by an encoder) at the crane, at the trolley, or at the sensor. In this case, the effort that is required to determine the mutually different sensor positions is reduced since they can be derived from the position of the trolley.

In accordance with a further embodiment, the evaluation unit can further be configured to perform a three-dimensional registration of the respective sets of spatial coordinates of the points for the plurality of mutually different sensor positions by means of a predefined algorithm. The predefined algorithm can be a classical algorithm, e.g. an Iterative Closest Point algorithm (ICP algorithm), or a model-based algorithm to fuse or to combine the respective sets of spatial coordinates of the points in accordance with the movement of the sensor. The model-based algorithm can use an algorithm of machine learning, such as a neural network.

When using the predefined algorithm, it is not necessary to detect the movement of the trolley to which the sensor can be attached in order to fuse the sets of spatial coordinates based on the movement of the trolley. The dependence of the apparatus on a further influencing variable or on an external measurement signal is thereby dispensed with.

Furthermore, the algorithm can use predetermined information with respect to the geometry of the container. Consequently, the algorithm is equipped with some prior knowledge with respect to the container and the position of the pick-up elements. The effort for executing the algorithm can thereby be reduced and the accuracy of the output, i.e. the respective spatial position of the pick-up elements of the container, can be improved.

Due to the fusion of the spatial coordinates (i.e. of measurement points), a dataset with a higher density of spatial coordinates/measurement points is thus e.g. provided.

The evaluation unit can further be configured to determine a spatial position and a spatial orientation of the container based on the fused totality of the coordinates of the points and to determine the respective spatial position of the pick-up elements of the container based on the spatial position and the spatial orientation of the container. In this embodiment, the determination of the spatial position of the pick-up elements thus takes place indirectly by first considering the container as a whole and adapting it to the point cloud, i.e. the fused totality of the coordinates of the points, with respect to its spatial position. Since the spatial position of the pick-up elements within the container can be known, the effort for determining the respective spatial position of the pick-up elements can thus be reduced since the container as a whole can be adapted to the point cloud in a simpler manner.

Furthermore, such an adaptation of the entire container compared to an adaptation of respective pick-up elements can take place with greater accuracy. The evaluation unit can, for example, adapt the fused totality of the coordinates to a simple model of the container, e.g. by means of a known fitting algorithm. Alternatively, an algorithm of machine learning can again be used, such as a neural network, to estimate the position and the orientation of the container.

Furthermore, the evaluation unit can be configured to determine a condition of the respective pick-up element of the container based on the fused totality of the coordinates of the points. In this embodiment, not only the spatial position but also further properties of the pick-up elements are determined. The condition of the respective pick-up element can comprise a defective condition, a condition with a twistlock in the respective pick-up element, or a condition without a twistlock in the respective pick-up element.

If a defective condition of one of the pick-up elements is determined based on the fused totality of the coordinates, the connection of a spreader or the twistlocks to the container can, for example, be prevented before attempting to lift the container. The risk of accidents that can, for example, be associated with the gripping of a defective corner casting or a defective pick-up element can thereby be reduced. The detection of a present or non-present twistlock in a respective pick-up element can furthermore simplify the control when lifting the container if the apparatus provides information regarding the conditions of twistlocks in the respective pick-up elements to other controls.

A further subject of the invention is a method for determining the spatial position of pick-up elements of a container. In accordance with the method, a respective set of spatial coordinates of points is acquired by means of a moving sensor for a plurality of mutually different sensor positions and/or with a plurality of mutually different sensor alignments. The points lie in a spatial region that comprises the container. Subsequently, the respective sets of spatial coordinates are combined into a fused totality of coordinates and a respective spatial position of the pick-up elements of the container is determined based on the fused totality of the coordinates.

Consequently, the apparatus described above is configured to perform the steps of the method by means of the moving sensor and the evaluation unit. The above embodiments of the apparatus in accordance with the invention thus also apply to the method in accordance with the invention, in particular with respect to the disclosure, the advantages, and the preferred embodiments.

The invention will be described in the following by way of example with reference to an advantageous embodiment and to the enclosed Figures. There are shown, schematically in each case:

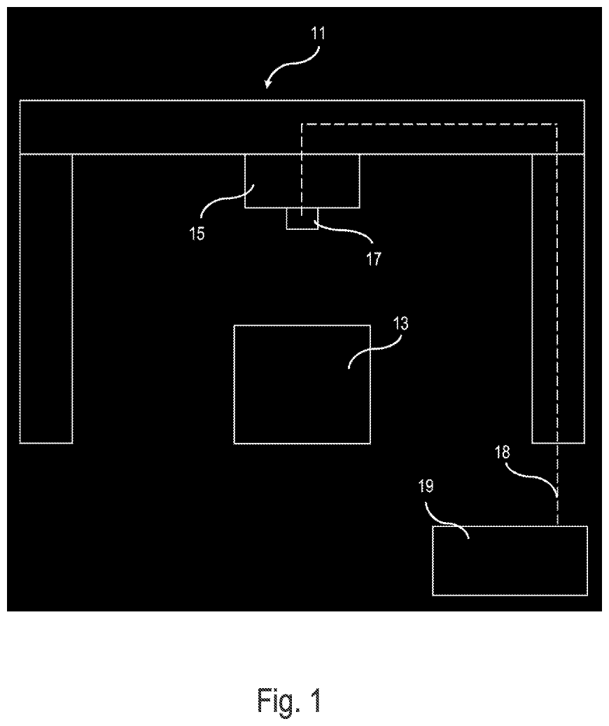

FIG. 1 a crane, a container, and an apparatus in accordance with the invention;

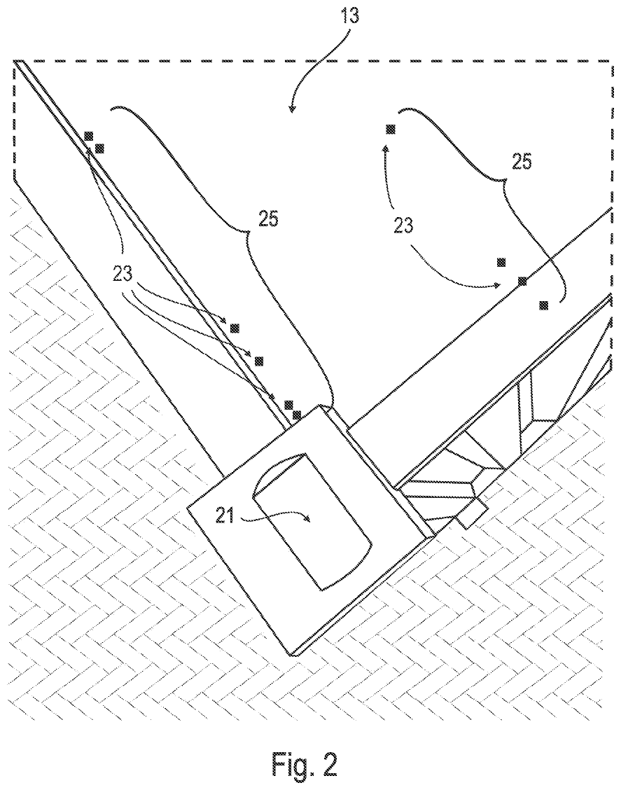

FIG. 2 a pick-up element of a container in the form of a corner casting;

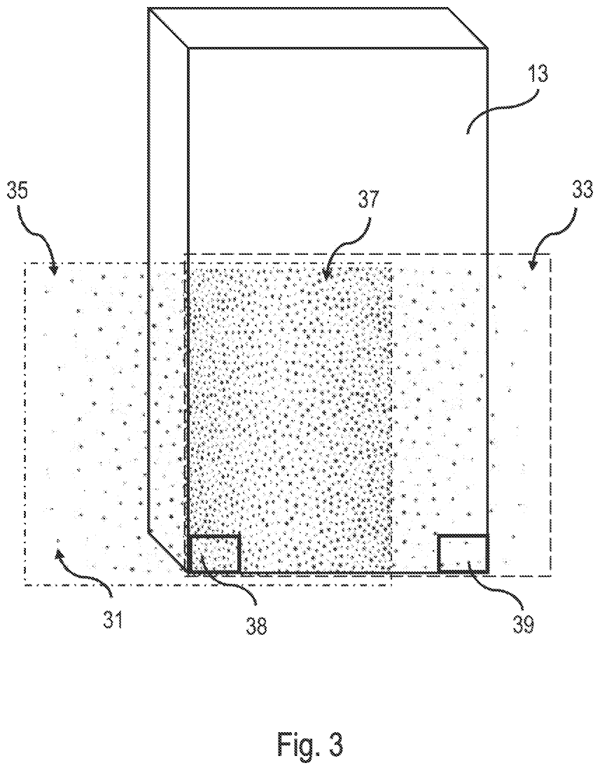

FIG. 3 a representation for the combination of two sets of points; and

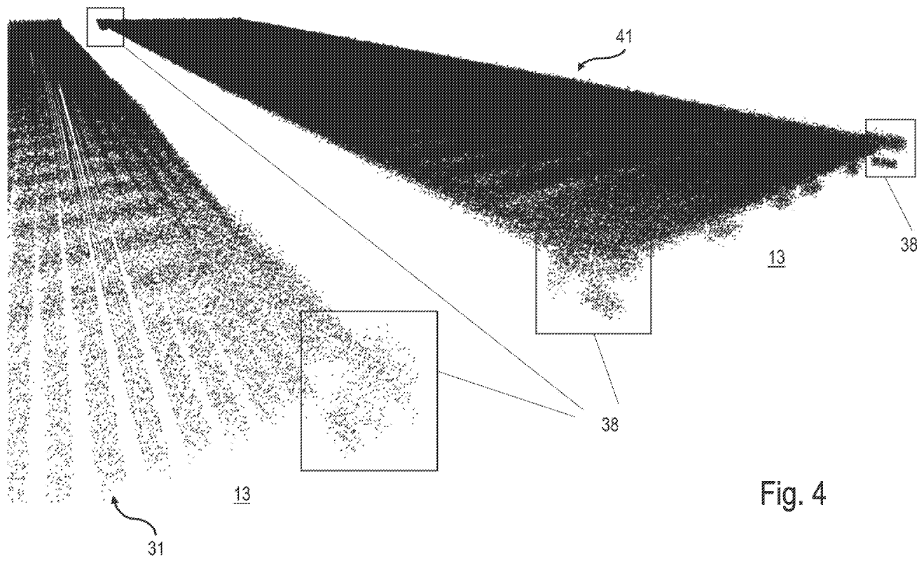

FIG. 4 a fused totality of points that were detected at the upper side of containers.

FIG. 1 shows a schematic representation of a crane 11 that is provided to move a container 13. For this purpose, the crane 11 comprises a trolley 15 to which a spreader, not shown, comprising so-called twistlocks is attached for lifting, moving, and setting down the container 13. The crane 11 is, for example, an STS crane (STS: Ship To Shore) or an RTG crane (RTG: Rubber Tyred Gantry), such as are typically used in modern port facilities.

A sensor 17, which is configured as a LIAR sensor, is fastened to the trolley 15. The sensor 17 therefore has a laser scanner that detects a certain spatial region at the upper side of the container 13. By means of a detection unit, the sensor 17 is further configured to acquire a set of spatial coordinates of points from the field of view of the sensor 17, i.e. at the upper side of the container 13.

The sensor 17 is further connected to an evaluation unit 19 by means of an electronic communication link 18. The evaluation unit 19 is provided to determine the respective spatial position of pick-up elements 21 (cf. FIG. 2) at the upper side of the container 13. The pick-up elements 21 are also designated as “corner castings” since they are arranged as cast parts in respective upper corners of the container 13. To lift the container 13, the twistlocks that are attached to the spreader, not shown, of the trolley 15 are each brought into engagement with and fastened to the pick-up elements or corner castings 21 of the container 13.

To reliably establish such a fastening, the positions of the pick-up elements or corner castings 21 as well as the position and orientation of the container as a whole must be known in an automated process in which the container is to be moved without a manual support and check. Furthermore, it is necessary that the condition of the corner castings 21 is also known, i.e. whether they are defect-free and whether a twistlock is currently arranged in the respective corner casting 21 or not.

In FIG. 2, in addition to the pick-up element or corner casting 21, points 23 are shown that were determined by means of a known sensor along laser lines 25 at the upper side of a container 13. The points 23 are thus the result of a scan along the two laser lines 25 by means of the known LIDAR sensor.

As can be seen in FIG. 2, the points 23 have a low density, which corresponds to a low resolution of the known LIDAR sensor. It could indeed be possible to determine the position and the orientation of the container 13 with the aid of the points 23 by means of a suitable evaluation method if known information of the geometry of the container 13 is provided for it. However, a reliable determination of the spatial position of the corner castings 21 is hardy possible based on the points 23.

To solve this problem due to the low spatial resolution of known LIDAR sensors, provision is made in accordance with the apparatus in accordance with the invention and the method in accordance with the invention that a respective set 33, 35 of spatial coordinates of points 31 is acquired (cf. FIG. 3) at a plurality of mutually different sensor positions by moving the sensor 17 (cf. FIG. 1) together with the trolley 15. In other words, during the movement of the trolley 15, respective scans are performed at the upper side of the container 13 at mutually different positions of the sensor 17 to determine a respective set 33, 35 of spatial coordinates of points 31 at the upper side of the container 13 at each of these positions of the sensor 17.

The respective sets 33, 35 of spatial coordinates of the points 31 are thus acquired by means of the sensor 17 at different points in time and starting from different spatial positions and are transmitted to the evaluation unit 19. The evaluation unit 19 combines the respective sets 33, 35 of the spatial coordinates or points 31 that are determined for the surface of the container 13 into a fused totality 41 (cf. FIG. 4) of coordinates or points 31.

An example of such a combination of two sets 33, 35 of points 31 is schematically shown in FIG. 3. In the region of the upper side of the container 13, a first point cloud or the first set 33 of points 31 and a second point cloud or the second set 35 of points 31, which have an overlap region 37, are acquired by means of the sensor 17 (cf. FIG. 1). For better illustration, the two point clouds 33, 35 are surrounded by a dashed line and a chain-dotted line, respectively, that are slightly offset from one another.

It can be seen that the density of the points 31 and thus the resolution of the sensor 17 in the overlap region 37 are significantly increased by the fusion of the two point clouds 33, 35. This in particular applies to the region 38 of the lower left corner casting of the container 13 that is disposed within the overlap region 37 and that has a greater density of points 31 than the region 39 of the right corner casting that is disposed outside the overlap region 37. By fusing the point clouds 33, 35, it is consequently possible to determine the spatial position of the corner casting in the region 38 with greater reliability.

FIG. 4 shows a fused totality 41 of points 31 that were determined at the upper side of two adjacent containers 13. The outlines of the containers 13 were omitted for reasons of clarity in FIG. 4. Nevertheless, the dimensions of the upper side of the right container 13 can be recognized based on the fused totality 41 of the points.

The fused totality 41 is formed by combining a plurality of respective sets of spatial coordinates of points 31 that were acquired at a corresponding plurality of mutually different sensor positions. To acquire the plurality of respective sets of points 31, the sensor 17 (cf. FIG. 1) was moved along the upper side of the container 13 together with the trolley 15. Thus, a movement of the sensor 17 relative to the container 13 took place in that the crane 11 as a whole was moved in a longitudinal direction with respect to the container and the trolley 15 was moved in a transverse direction with respect to the container.

To combine the plurality of sets of spatial coordinates or points 31, the respective positions of the trolley 15 during its movement were detected for each set. Based on the displacement of the trolley 15, the evaluation unit 19 determined the spatial position of the respective sets of coordinates that were determined at the respective sensor positions to subsequently combine the sets of the coordinates and to form the fused totality 41 of the points that is shown in FIG. 4.

Furthermore, spatial regions 38 in which the corner castings 21 (see FIG. 2) are located are again shown in FIG. 4. As can be seen in FIG. 4, the density of the points within the spatial regions 38 is sufficient to determine the spatial position of the corner castings or pick-up elements 21 of the container 13. Such a determination takes place by means of a suitable algorithm directly based on the points within the spatial regions 38, either by adapting a geometric model of the corner castings 21 to the points or by evaluating the sets of spatial coordinates of the points 31 in the spatial region 38, for example with respect to statistics of the z values of the points, i.e. perpendicular to the upper side of the container 13. Alternatively or additionally, it is also possible to determine the spatial position of the container 13 as a whole based on the fused totality 41 of points, for example, also by adapting a geometric model for the container 13. Subsequently, the spatial position of the corner castings within the spatial regions 38 can be determined based on the determined spatial position of the entire container 31 by, for example, again using a known container geometry as “a priori knowledge”, so to speak.

Overall, the apparatus and the method permit an accurate determination of the spatial position of the pick-up elements or corner castings 21 of the container 13 by acquiring a plurality of sets 33, 35 of points 31 at mutually different positions of the sensor 17 and combining them into the fused totality 41 of points 31. The density of the points 31 and thus the corresponding spatial resolution of the apparatus are thereby improved so that the spatial position of the pick-up elements or corner castings 21 can be determined with greater reliability.

Furthermore, the condition of the pick-up elements 21 can be determined based on the points 31 within the spatial regions 38 (cf. FIG. 4). This means that, based on the points within the spatial regions 38, a decision can be made whether the respective pick-up element or corner casting 21 is defect-free. This can, for example, take place by adapting a model of the corner castings 21 to the points 31 in the regions 38 and by calculating the average deviations or distances of the points 31 from the adapted model. Similarly, based on the points 31 within the spatial regions 38, it can be determined whether a twistlock is arranged in the respective pick-up element 21 or not. The degree of automation in the handling of containers can thereby be further improved by means of the apparatus in accordance with the invention and the method in accordance with the invention.

### REFERENCE NUMERAL LIST

11 crane
13 container
15 trolley
17 sensor
18 electronic communication link
19 evaluation unit
21 pick-up element or corner casting
23 points
25 laser line
31 points
33 first point cloud or first set of points
35 second point cloud or second set of points
37 overlap region
38, 39 region of the pick-up elements or corner castings
41 fused totality of coordinates or points

1. An apparatus for determining the spatial position of pick-up elements of a container, said apparatus comprising:
a moving sensor that is configured to acquire a respective set of spatial coordinates of points for a plurality of mutually different sensor positions,
wherein the points He in a spatial region that comprises the container; and
an evaluation unit that is configured:
to combine the respective sets of spatial coordinates into a fused totality of coordinates,
to determine a respective spatial position of the pick-up elements of the container based on the fused totality of the coordinates of the points.

2. The apparatus in accordance with claim 1, wherein
the plurality of mutually different sensor positions are associated with a respective point in time at which the moving sensor acquires a respective set of the spatial coordinates of the points.

3. The apparatus in accordance with claim 1, wherein
the moving sensor comprises one or more sensors and a device for respectively tilting the one or more sensors.

4. The apparatus in accordance with claim 1, wherein
the sensor is attached to a trolley of a crane, said crane being provided to move the container, and
the evaluation unit is further configured:
to detect a current position of the trolley and
to determine a respective one of the mutually different sensor positions based on the current position of the trolley.

5. The apparatus in accordance with claim 1, wherein
the evaluation unit is further configured:
to perform a three-dimensional registration of the respective sets of spatial coordinates of the points for the plurality of mutually different sensor positions by means of a predefined algorithm.

6. The apparatus in accordance with claim 5, wherein
the algorithm uses predetermined information with respect to the geometry of the container.

7. The apparatus in accordance with claim 1, wherein
the evaluation unit is further configured:
to determine a spatial position and a spatial orientation of the container based on the fused totality of the coordinates of the points, and
to determine the respective spatial position of the pick-up elements of the container based on the spatial position and the spatial orientation of the container.

8. The apparatus in accordance with claim 7, wherein
the evaluation unit adapts the fused totality of the coordinates to a model of the container.

9. The apparatus in accordance with claim 1, wherein
the evaluation unit is further configured to determine a condition of the respective pick-up element of the container based on the fused totality of the coordinates of the points.

10. A method for determining the spatial position of pick-up elements of a container, wherein the method comprises:
a respective set of spatial coordinates of points being acquired by means of a moving sensor for a plurality of mutually different sensor positions,
wherein the points lie in a spatial region that comprises the container,
the respective sets of spatial coordinates being combined into a fused totality of coordinates, and
a respective spatial position of the pick-up elements of the container being determined based on the fused totality of the coordinates of the points.
